(19) United States
(12) Patent Application Publication
(10) Pub. No.: US 2013/0025106 A1
(43) Pub. Date: Jan. 31, 2013

(54) RETENTION MECHANISM TO RETAIN A CONCENTRATOR NOZZLE TO A HAIR BLOW DRYER AIR DISCHARGE OUTLET TO PREVENT THE CONCENTRATOR NOZZLE FROM INADVERTENTLY DETACHING FROM THE OUTLET DURING OPERATION OF THE HAIR BLOW DRYER

(71) Applicant: Alan I. Hernandez-Laines, Stamford, CT (US)

(72) Inventor: Alan I. Hernandez-Laines, Stamford, CT (US)

(21) Appl. No.: 13/190,819

(22) Filed: Jul. 26, 2011

(51) Int. Cl. A45D 20/00; B23P 11/00

(52) U.S. Cl. 29/428; 285/317

(57) ABSTRACT

A mechanism that prevents inadvertent detachment of a concentrator nozzle from an air discharge outlet of a hair blow dryer during hair blow dryer operation. The mechanism may be a button neighboring an air discharge outlet of a hair blow dryer and a plurality of button receiving regions (such as three) neighboring an inlet of a concentrator nozzle attachment. As an alternative, the button may neighbor the inlet of the concentrator nozzle instead and the button receiving regions may neighbor the air discharge outlet instead. A resilient, elastic strip or band may be positioned between the hair blow dryer outlet and the concentrator nozzle attachment inlet.

### BACKGROUND OF THE INVENTION

1. Field of the Invention

The present invention relates to a retention mechanism that retains a concentrator nozzle to a hair blow dryer air discharge outlet in a manner that prevents the concentrator nozzle from detaching from the outlet during use of the hair blow dryer.

2. Discussion of Related Art

A hand-held hair blow dryer and attachments are known. One such attachment is a concentrator nozzle. The concentrator nozzle attaches to an air discharge outlet of the hair blow dryer. The inventor has seen, in a hair salon, the concentrator nozzle inadvertently detach from the hair blow dryer during operation of the hair blow dryer and be blown away (“fly off”) to bounce along the floor, which creates noise and unwanted pandemonium as the hair stylist seeks to retrieve the concentrator nozzle that went astray and then sanitize it before reuse since it hit the floor.

It is therefore desired to rectify the problem of concentrator nozzle fly off by devising a permanent solution that effectively prevents unwanted detachment of the concentrator nozzle from the air discharge outlet of a hair blow dryer.

### SUMMARY OF THE INVENTION

One aspect of the invention arises from a mechanism that prevents inadvertent detachment of a concentrator nozzle from an air discharge outlet of a hair blow dryer.

Another aspect of the invention relates to an apparatus that retains attachment in a manually releasable manner yet prevents inadvertent detachment of two components, which are a hair blow dryer and a concentrator nozzle attachment. The concentrator nozzle attachment defines a passage between an inlet and an outlet that constricts volume in a direction from the inlet to the outlet. The outlet is elongated to define a substantially rectangular opening. The hair blow dryer having an elongated handle

Each component may have respective formations that are compatible to effect engagement with each other into any one of a plurality of engagement positions that blocks the two components from separating from each other. The respective formations are also compatible with each other to effect disengagement with each other that frees the two components to separate from each other by moving the respective formations out of the engagement with each other.

The respective formations are arranged to engage each other in any desired one of a plurality of the engagement positions that correspond with respective relative orientations of the substantially rectangular opening and the elongated handle. The relative orientations are selected from the group consisting of the substantially rectangular opening and the elongated handle being substantially in alignment with each other with respect to a direction of elongation of each, the substantially rectangular opening and the elongated handle being substantially transverse to each other with respect to the direction of elongation of each, and the substantially rectangular opening and the elongated handle being substantially at an oblique angle with respect to the direction of elongation of each.

A button may neighbor the air discharge outlet and a plurality of button receiving regions (such as three) may neighbor the inlet of the concentrator nozzle. As an alternative, the button may neighbor the inlet of the concentrator nozzle instead and the button receiving regions may neighbor the air discharge outlet instead. Either way, the button projects outwardly to enter the button receiving region and thereby retain the two components to each other. The button receiving region may be openings or grooves.

A resilient, elastic band or strip may be provided between the inlet of the concentrator nozzle attachment and the outlet of the hair blow dryer.

### BRIEF DESCRIPTION OF THE DRAWING

For a better understanding of the present invention, reference is made to the following description and accompanying drawings, while the scope of the invention is set forth in the appended claims.

FIG. 1 shows an elevation view of a hair blow dryer equipped with a spring-biased button in accordance with the invention.

FIG. 2 shows a top view of the hair blow dryer of FIG. 1.

FIG. 3 shows a side view of a concentrator nozzle equipped with three button receiving regions in accordance with the invention.

FIG. 4 shows a top view of the concentrator nozzle of FIG. 3.

FIG. 5 shows an elevation view of the concentrator nozzle of FIGS. 3 and 4 attached to the hair blow dryer of FIGS. 1 and 2.

FIG. 6 shows an elevation view of a conventional air blow dryer.

FIG. 7 shows a top view of the conventional air blow dryer of FIG. 6.

FIG. 8 shows a side view of a conventional concentrator nozzle.

FIG. 9 shows an elevation view of a concentrator nozzle attachment in accordance with a further embodiment of the invention for engagement with a hair blow dryer.

FIG. 10 shows a top plan view of the concentrator nozzle attachment of FIG. 9.

FIG. 12 shows an elevation view of a hair blow dryer in accordance with the invention suited to engage with the concentrator nozzle attachment of FIGS. 9 and 10.

FIG. 10 shows a conventional concentrator nozzle attachment and a conventional hair dryer that engage each other together and which are retained by a resilient, elastic band in accordance with another embodiment of the invention.

### DETAILED DESCRIPTION OF THE PREFERRED EMBODIMENT

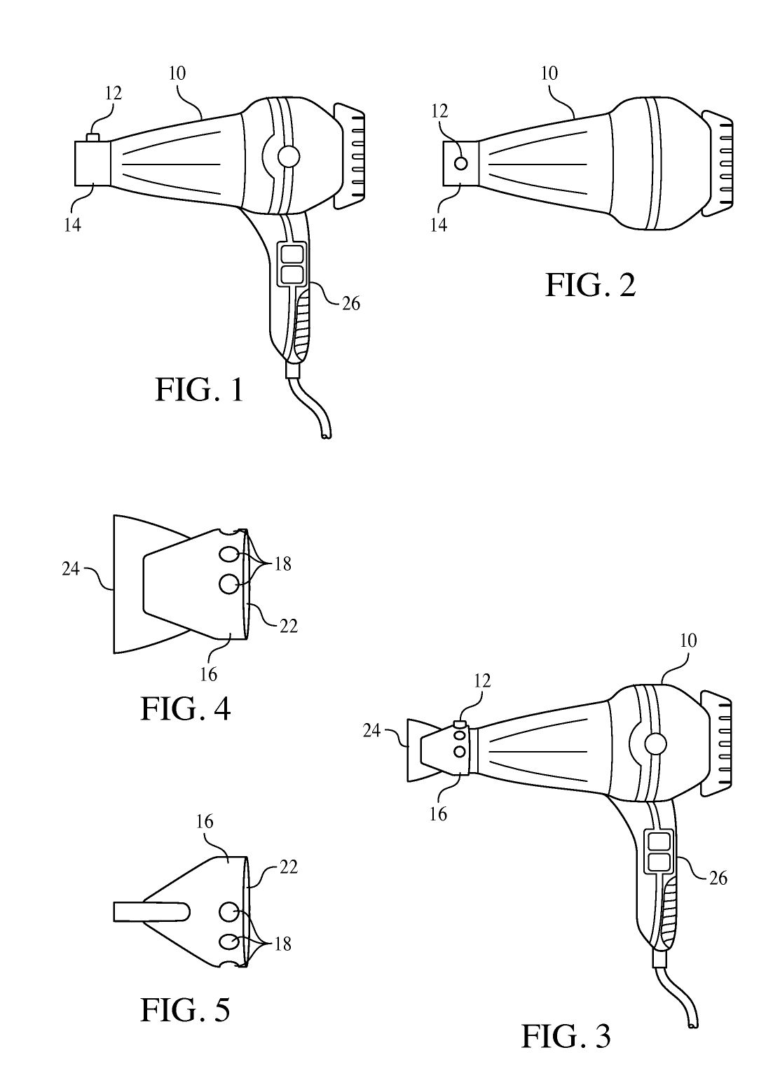

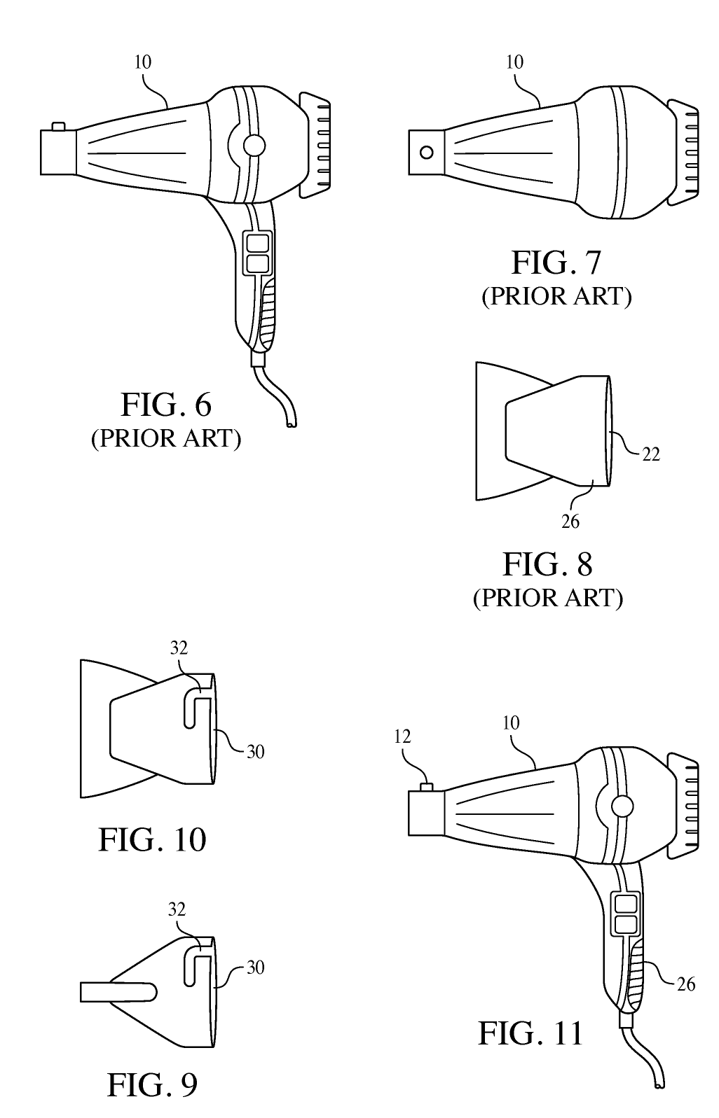

Turning to the drawing, a conventional hair blow dryer and concentrator nozzle attachment are shown in FIGS. 6-8. Three embodiments of the invention are shown in FIGS. 1-5, FIG. 9 and FIG. 10. In effect, FIGS. 6-8 may be considered “before” modification by the invention views and FIGS. 1-5, FIG. 9 and FIG. 10 may be considered “after” modification by the invention views.

FIGS. 1-2 show a handheld hair blow dryer 10 having a spring-biased button 12 neighboring an air discharge outlet 14 in accordance with the invention. FIGS. 3-4 show a concentrator nozzle attachment 16 with three button receiving regions 18 in succession adjacent the rim 20 of the circular inlet opening 22 of the concentrator nozzle attachment 16 in accordance with the invention. The concentrator nozzle attachment 16 also has a restricted, substantially rectangular outlet opening 24 that is bounded by an elongated wall. That is, the elongated wall is elongated in substantially the same direction as the direction of elongation of the substantially rectangular outlet opening 24.

FIG. 5 shows the concentrator nozzle attachment 16 secured to (e,g., mechanically engaged with) and in fluid communication with the air discharge outlet 14. The spring-biased button 12 is shown projected so as to project through an aligned one of the button receiving regions 18. To detach, the spring-biased button 12 is pressed against bias into a retracted position that allows the free rotation of the concentrator nozzle attachment 16 relative to the air discharge outlet 14. In so rotating the spring-biased button 12 may align with any other ones of the button receiving regions 18 and then be released under the spring bias to project through the aligned one of the button receiving regions.

If desired, the three button receiving regions may instead be neighboring the air discharge outlet 14 of the handheld hair blow dryer 10 of FIGS. 1-2.

FIGS. 6-7 show a conventional handheld hair blow dryer 20 that lacks the spring-biased button of FIG. 1. FIG. 8 shows a conventional concentrator nozzle attachment 26 that has no button receiving regions neighboring a rim of its inlet opening 22.

As long as the concentrator nozzle attachment 26 remains attached to the air discharge outlet of the hair blow dryer 10, use of the hair blow dryer 10 to concentrate the airflow through the concentrator nozzle onto the hair being styled is satisfactory. However, when the concentrator nozzle attachment detaches on its own during operation of hair blow dryer, the result is unsatisfactory and a cause of frustration and potential embarrassment.

As a hair stylist with years of experience as a working professional, the inventor has seen concentrator nozzle attachments literally fly off air discharge outlets of hair blow dryers to which they were attached as a consequence of their becoming detached during use. Such a flying off effect has happened while the hair blow dryers are being used to style the hair of customers.

Conventional concentrator nozzle attachments, such as that of FIG. 8, typically have an inlet sized substantially the same dimension as the air discharge outlets of hair blow dryers. The concentrator nozzle attachment 26 also has a constricting portion that constricts the airflow emerging from the air discharge outlet of the hair blow dryer to concentrate the airflow. The concentrator nozzle attachment 26 has a restricted opening of rectangular shape, that is, more restricted in dimensional size as compared to the circular size of the concentrator nozzle inlet. As a consequence of the constriction, the airflow blows against the inside surface of the constricted portion.

What happens is that during operation of the hair blow dryer, the concentrator nozzle attachment 26 eventually detaches from the air discharge outlet of the hair blow dryer 10. Since the hair blow dryer 10 is still operating at the time, air continues to be discharged. Since the discharged air was blowing against the constricted portion of the concentrator nozzle attachment 26 while the concentrator nozzle attachment 26 was attached, it continues to blow against the constricted portion at the moment of detachment. Since there is no longer anything restraining the concentrator nozzle attachment 26 once it detaches, the full force of the discharged air urges the concentrator nozzle attachment 26 to in effect fly off. The result is chaotic since the concentrator nozzle is moving at a rapid speed with little air resistance to slow it down.

Once the concentrator nozzle attachment 26 reaches the ground, it inevitably makes loud noises on impact and bounces in an unpredictable direction (since the floors of hair salons are uncarpeted as a general rule to avoid fallen, cut hair from getting entangled with carpet fiber strands). The hair stylist is thus compelled to chase after the bouncing concentrator nozzle attachment 26 that has gone astray while everyone in the salon turns to look at what the commotion is all about after hearing the loud noises made from impact of the concentrator nozzle attachment 26 with the floor. What they see is a small part bouncing randomly on the floor in a direction away from the hair stylist with the hair stylist stooping low in an effort to retrieve it. Such a scene, obviously, is embarrassing to the hair stylist who is chasing after the concentrator nozzle attachment 26 and very frustrating since it is likely to happen again and again over time. Once the hair stylist retrieves the concentrator nozzle attachment 26 from the floor, the concentrator nozzle attachment 26 needs to be sanitized before it can be reused. The customer(s) may otherwise take offense at continued use of the hair blow dryer with the same attachment if it is left unsanitized after touching the floor. There could well be legitimate sanitary concerns against immediate reuse, because any dirt or dust particles from the floor that are picked up by the concentrator nozzle attachment 26 as it bounced could well cling to hair if blown into the hair by the hair blow dryer 10.

As concerns the problem of unintentional detachment of the concentrator nozzle attachment 26 from the hair blow dryer 10 during operation, little or nothing has been done in the industry to rectify the situation. Perhaps the detachment arises due to gradual thermal stress imposed at the detachment location from the high temperature of the airflow. Perhaps the detachment arises due to repeated attachment and detachment of the concentrator nozzle attachment 26 with the air discharge outlet of the hair blow dryer that eventually wears the region sufficiently that the attachment is no longer as secure as it was when brand new. Perhaps the detachment arises due to a combination of these factors or because of other cause, e.g., vibrational effects imparted to the hair blow dryer housing from the vibrating motor of the hair blow dryer.

Turning again to the embodiment of FIGS. 1-5, the three button receiving regions 18 allow the hair stylist to orient the restricted discharge outlet of the concentrator nozzle attachment 16 into any one of three relative positions. When the spring-biased button 12 is biased into one of the end ones of the three button receiving regions 18, the concentrator nozzle attachment 16 is oriented substantially in alignment with the direction of elongation of the handle of the hair blow dryer 10. When the spring-biased button 12 is biased into one of the end ones of the three button receiving regions 18, the concentrator nozzle attachment 16 is oriented substantially transverse to the direction of elongation of the handle of the hair blow dryer 10. When the spring-biased button 12 is biased into the central one of the three button receiving regions 18, the concentrator nozzle attachment 16 is oriented substantially at an oblique angle (such as a 45 degree angle) between being in alignment with the handle and being transverse to the direction of elongation of the handle.

For example, if the concentrator nozzle attachment 16 of FIG. 4 is fitted in the orientation shown onto the air discharge outlet 14 of the hair blow dryer 10 of FIG. 1 in the orientation shown (i.e., in which the spring-biased button 12 is inserted into the aligned end one of the three button receiving regions 18), the result would be that the rectangular, restricted opening 24 of the concentrator nozzle attachment 16 is in alignment with the direction of elongation of the handle 26. That is, the result would be the orientation as reflected in FIG. 3. However, if the concentrator nozzle attachment 16 were rotated so that the other end one of the three button receiving regions were in alignment with the spring-biased button 12, the result would be that the rectangular, restricted opening 24 of the concentrator nozzle attachment 16 is transverse to the direction of elongation of the handle 26 of the hair blow dryer 10, i.e., the concentrator nozzle attachment 16 would be orientation 180 degrees rotated from that of FIG. 5. An intermediate position (an oblique angle such as 45 degrees) would result from rotating the concentrator nozzle attachment 16 relative to the air discharge outlet 14 until the central one of the three button receiving regions 18 aligned with the spring-biased button 12.

After the concentrator nozzle attachment 16 is attached at the air discharge outlet 14 of the hair blow dryer 10, i.e., with the spring-biased button 12 inserted into any desired one of the three button receiving regions 18, it is a simple matter to switch insertion to a different button receiving region. Simply depress the spring-biased button 12 against bias into the retracted position with one finger while holding the concentrator nozzle attachment 16 with the remainder of the hand. The handle 24 of the air blow dryer 10 is held with the other hand.

At this point, the concentrator nozzle attachment 16 may be removed entirely from the hair blow dryer 10, rotated relative to the air discharge outlet 14 until the desired one of the button receiving regions 18 is approximately in line with the spring-biased button 12 so that pushing the concentrator nozzle attachment 16 onto the hair blow dryer 10 will result eventually in the spring-biased button 12 being urged under spring bias to insert into the desired one of the button receiving regions 18 upon alignment.

As an alternative to removal of the concentrator nozzle attachment 16 from the hair blow dryer for repositioning, the concentrator nozzle attachment 16 may instead be rotated relative to the air discharge outlet 14 until the desired one of the button receiving regions 18 aligns with the spring-biased button 12, where the spring-biased button 12 urges under spring bias to insert into the desired one of the button receiving regions 18. If, prior to reaching the desired alignment, the spring-biased button 12 aligns with an intermediate one of the button receiving regions 18 (such as the central one), then one need only depress the spring-biased button 12 again to its retracted position to continue the desired relative rotation until the desired button receiving region alignment is attained.

Each button receiving region 18 may be a distinct hole or be a distinct groove. The spring-based button may be shaped round or oblong so as to fit into the button receiving region 18.

The hair blow dryer and the concentrator nozzle attachment may be considered to be two components. The button receiving regions 18 and the spring-biased buttons may be considered to be formations that align and are movable into a desired one of a plurality of engaged positions with each other to block the two components from separating from each other and that are thereafter movable out of the engaged position and into a disengaged position where the two components separate from each other.

If desired, the button receiving regions 18 may instead be a plurality of buttons and the spring-biased button 12 may instead be a button receiving region.

Turning to FIGS. 9-11, a further embodiment of the concentrator nozzle attachment is shown. An inverted L-shaped opening 30 is shown with two legs. One leg extends substantially in the longitudinal direction of the concentrator nozzle and opens at the rim 32 of the concentrator nozzle attachment. The other leg extends transverse to the one leg to terminate at a distal end and communicates at its proximal end with the one leg to form a right angle between the legs. The inverted L-shaped opening constitutes a groove.

A button 12, which need not be spring-based, is slid into the one leg that opens to the rim 30 and is then slid into the second leg, which retains the button in its relative position at its distal end until the button is manually moved out. A series of these L-shaped openings 30 are provided spaced from each other such that when the button reaches its retained position in the second leg of whichever desired one of the series of L-shaped openings 30 is selected, the relative position of the substantially rectangular opening at the outlet of the concentrator nozzle with respect to the elongated handle of the hair blow dryer is either in alignment, transverse or at an oblique angle depending upon which of the openings 30 are selected.

It should be understood that the embodiment of FIG. 9 may be modified such that the concentrator nozzle attachment has one or more buttons instead of L-shaped openings (or grooves) 30 and the outlet of the hair blow dryer would have one or more of the L-shaped openings (or grooves) 30 that are arranged to engage the one or more buttons.

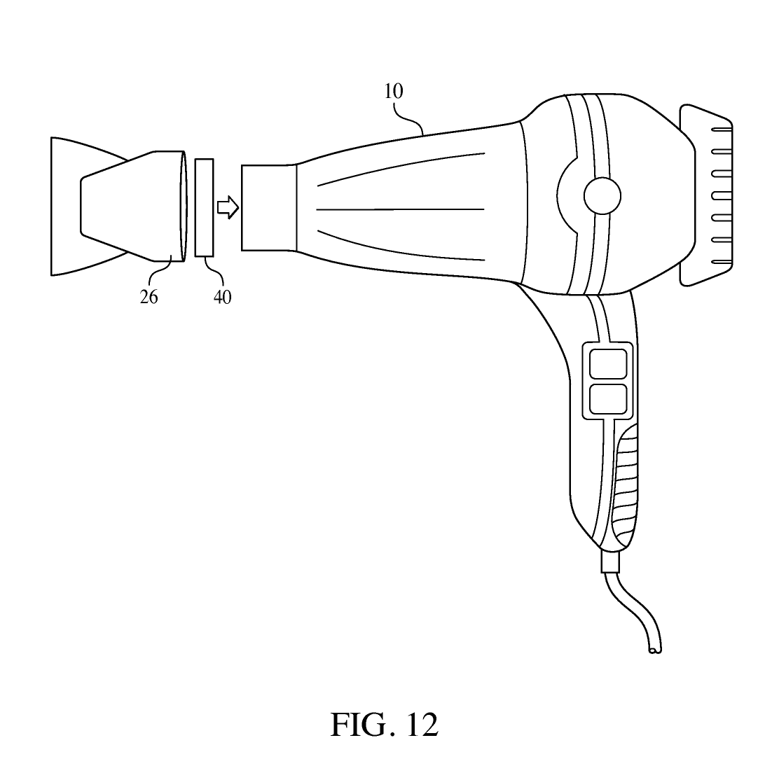

Turning to FIG. 12, another embodiment is shown to use a resilient, elastic strip or band 40 between the inlet of one of the components and the outlet of the other of the components to retain the two components to each other so as to prevent inadvertent separation. If the inlet of the one component fits into the outlet of the other component, then the resilient, elastic strip is wrapped onto and/or adhered to the external facing surface of the inlet or else could be adhered to the internal facing surface of the outlet. If the outlet of the one component fits into the inlet of the other component, then the resilient, elastic strip is wrapped onto and/or adhered to the external facing surface of the outlet or else could be adhered to the internal facing surface of the inlet. The resilient, elastic strip 40 should be thermally resistant to exposure to temperature normally reached by air blow dryers so as to prevent it from breaking under thermal stresses and strains. The resilient, elastic strip may be made of ethylene propylene rubber or hydrogenated nitrile rubber (resistant to high temperature of 180 degrees C.), fluorelastomers or perfluoro elastomers, silicone rubber, fluorosilicone rubber, tand retra-fluoroethylene/propylene (resistant to high temperatures of 200 degrees C.).

If desired, the elastic strip or band 40 may be used as well in conjunction with the embodiments of FIGS. 1-5 and/or FIGS. 9-11.

While the foregoing description and drawings represent the preferred embodiments of the present invention, various changes and modifications may be made without departing from the scope of the present invention.

What is claimed is:

1. An apparatus that retains attachment in a manually releasable manner yet prevents inadvertent detachment, comprising
two components mechanically engaged with each other, one of the two components being a hair blow dryer and a remaining one of the two components being a concentrator nozzle attachment, the concentrator nozzle attachment defining a passage between an inlet and an outlet that constricts volume in a direction from the inlet to the outlet, the outlet being elongated to define a substantially rectangular opening, the hair blow dryer having an elongated handle and blowing heated air at elevated temperatures above ambient temperature through a discharge outlet of the hair blow dryer and into the passage via the inlet of the concentrator nozzle attachment; and
preventing means for preventing inadvertent detachment of the two components yet retaining the two components in any desired one of a plurality of the engagement positions that correspond with respective relative orientations of the substantially rectangular opening and the elongated handle, the relative orientations being selected from the group consisting of the substantially rectangular opening and the elongated handle being substantially in alignment with each other with respect to a direction of elongation of each, the substantially rectangular opening and the elongated handle being substantially transverse to each other with respect to the direction of elongation of each, and the substantially rectangular opening and the elongated handle being substantially at an oblique angle with respect to the direction of elongation of each, said preventing means being selected from the group consisting of a resilient, elastic element between the two components and a button protruding from one of the two components to enter a button retaining region in another of the two components and any combination thereof.

2. The apparatus of claim 1, wherein the two components each having respective formations, the respective formations being compatible with each other to effect engagement with each other into any one of the plurality of engagement positions that blocks the two components from separating from each other, the respective formations being compatible with each other to effect disengagement with each other that frees the two components to separate from each other by moving the respective formations out of the engagement with each other, the respective formations being arranged to engage each other in any desired one of the plurality of the engagement positions that correspond with respective relative orientations of the substantially rectangular opening and the elongated handle, the respective formations being the button and the button retaining region.

3. The apparatus of claim 2, wherein the button retaining region is selected from a group consisting of an opening and a substantially right angled channel.

4. The apparatus of claim 1, wherein the preventing means in the resilient, elastic element, the resilient, elastic element being selected from the group consisting of a resilient, elastic strip and a resilient, elastic band.

5. The apparatus of claim 4, wherein the resilient elastic element is the resilient, elastic strip, the resilient, elastic strip being adhered to one of the two components.

6. The apparatus of claim 4, wherein the resilient elastic element is the resilient, elastic band, the resilient, elastic band being wrapped onto one of the two components.

7. A method that retains attachment in a manually releasable manner yet prevents inadvertent detachment, comprising mechanically engaging two components with each other, one of the two components being a hair blow dryer and a remaining one of the two components being a concentrator nozzle attachment, the concentrator nozzle attachment defining a passage between an inlet and an outlet that constricts volume in a direction from the inlet to the outlet, the outlet being elongated to define a substantially rectangular opening, the hair blow dryer having an elongated handle and blowing heated air at elevated temperatures above ambient temperature through a discharge outlet of the hair blow dryer and into the passage via the inlet of the concentrator nozzle attachment; and
preventing inadvertent detachment of the two components yet retaining the two components in any desired one of a plurality of the engagement positions that correspond with respective relative orientations of the substantially rectangular opening and the elongated handle, selecting the relative orientations from the group consisting of the substantially rectangular opening and the elongated handle being substantially in alignment with each other with respect to a direction of elongation of each, the substantially rectangular opening and the elongated handle being substantially transverse to each other with respect to the direction of elongation of each, and the substantially rectangular opening and the elongated handle being substantially at an oblique angle with respect to the direction of elongation of each, carrying out the preventing by selecting from the group consisting of positioning a resilient, elastic element between the two components and protruding a button from one of the two components to enter a button retaining region in another of the two components and any combination thereof.

8. The method of claim 7, further comprising providing the two components each with respective formations that are compatible with each other to effect engagement with each other into any one of a plurality of engagement positions that blocks the two components from separating from each other, the respective formations being compatible with each other to effect disengagement with each other that frees the two components to separate from each other by moving the respective formations out of the engagement with each other, arranging the respective formations to engage each other in any desired one of the plurality of the engagement positions that correspond with respective relative orientations of the substantially rectangular opening and the elongated handle, the respective formations being the button and the button receiving region.

9. The method of claim 8, further comprising selecting at least one set of the respective formations to be a plurality of the button accommodating regions formed by punching or cutting an associated one of the two components a plural number of times to form the plurality of button accommodating regions.

10. The method of claim 8, further comprising selecting at least one set of the respective formations to be a plurality of the button accommodating regions formed by molding an associated one of the two components to form the plurality of button accommodating regions.

11. The method of claim 8, further comprising selecting the button retaining region from a group consisting of an opening and a substantially right angled groove.

12. The method of claim 8, wherein the preventing is carried out with the resilient, elastic element, the resilient, and selecting the elastic element from the group consisting of a resilient, elastic strip and a resilient, elastic band.

13. The method of claim 8, wherein the resilient elastic element is the resilient, elastic strip, and adhering the resilient, elastic strip to one of the two components.

14. The method of claim 8, wherein the resilient elastic element is the resilient, elastic band, and wrapping the resilient, elastic band onto one of the two components.
